(19) United States
(12) Patent Application Publication
(10) Pub. No.: US 2022/0097001 A1
(43) Pub. Date: Mar. 31, 2022

(54) MIXING MEMBER, EXHAUST PURIFICATION DEVICE AND VEHICLE

(71) Applicant: ISUZU MOTORS LIMITED, Tokyo (JP)

(72) Inventor: Kento KANEDA, Fujisawa-shi, Kanagawa (JP)

(21) Appl. No.: 17/298,051

(22) PCT Filed: Nov. 22, 2019
(86) PCT No.: PCT/JP2019/045792

§ 371 Date: May 28, 2021

(30) Foreign Application Priority Data
Nov. 29, 2018 (JP) 2018-223380

(51) Int. Cl. B01D 53/94; B01F 23/213; B01F 25/421; B01F 25/432; F01N 3/20; F01N 3/28

(52) U.S. Cl. CPC B01D 53/9431; B01F 23/2132; B01F 25/4231; B01F 25/4323; F01N 2610/02; F01N 3/2892; B01D 2251/2067; B01D 2255/911; F01N 3/2066

(57) ABSTRACT

This mixing member, which, in an exhaust pipe, mixes exhaust gas and a reducing agent supplied in a supply direction that is inclined with respect to the emission direction of exhaust gas flow, has a main body comprising a gas inlet, a gas outlet, and a gas flow path which connects the gas inlet and the gas outlet and inside of which the exhaust gas and the reducing agent are mixed. When arranged inside the exhaust pipe, the gas inlet is provided in the end surface of the main body part that is positioned on the upstream side in the emission direction. The end surface is arranged inclined relative to the emission direction so as to face upstream in the supply direction of the reducing agent. The gas flow path is inclined relative to the supply direction and extends in parallel with the emission direction.

### TECHNICAL FIELD

The present disclosure relates to a mixing member, an exhaust purification apparatus, and a vehicle.

### BACKGROUND ART

In the related art, for an exhaust purification apparatus for an internal combustion engine, a configuration is known in which ammonia is generated by a reducing agent such as urea water and reduction action of the ammonia and nitrogen oxide in an exhaust gas is promoted using a selective reduction catalyst. For such a configuration, a configuration including a mixing member for mixing a reducing agent and an exhaust gas is known.

For example, Patent Literature (hereinafter, referred to as “PTL”) 1 discloses a configuration including: a reducing agent supply part disposed inclined with respect to an emission direction; and a mixing member disposed vertically with respect to a supply direction of a reducing agent of the reducing agent supply part. In this configuration, the mixing member directly receives the reducing agent supplied from the reducing agent supply part, thereby improving mixing efficiency of the reducing agent and an exhaust gas, and further improving purification efficiency of the exhaust gas.

### CITATION LIST

### Patent Literature

PTL 1
Japanese Patent Application Laid-Open No. 2017-180133

### SUMMARY OF INVENTION

### Technical Problem

In the configuration described in PTL 1, however, a gas flow path in the mixing member is parallel to the supply direction of the reducing agent so that there is a case where the reducing agent passes through the gas flow path as it is, without being mixed by the mixing member, to be deposited on a downstream side of the mixing member. For this reason, the configuration described in PTL 1 has certain limitations as a configuration of improving mixing efficiency of a reducing agent and an exhaust gas.

An object of the present disclosure is to provide a mixing member, an exhaust purification apparatus, and a vehicle that are capable of improving mixing efficiency of an reducing agent and an exhaust gas, and further improving purification efficiency of the exhaust gas.

### Solution to Problem

A mixing member according to the present disclosure mixes a reducing agent and an exhaust gas in an exhaust pipe. The reducing agent is supplied in a supply direction inclined with respect to an emission direction in which the exhaust gas flows. The mixing member includes a main body part. The main body part includes: a gas inlet; a gas outlet;

and a gas flow path communicating the gas inlet with the gas outlet and causing the exhaust gas and the reducing agent to be mixed therein. The gas inlet is provided on an end surface of the main body part. The end surface is located on an upstream side in the emission direction when the mixing member is disposed in the exhaust pipe. The end surface is disposed inclined with respect to the emission direction so as to face an upstream side in the supply direction of the reducing agent. The gas flow path is inclined with respect to the supply direction and extends parallel to the emission direction.

An exhaust purification apparatus according to the present disclosure includes: the exhaust pipe; a selective reduction catalyst provided in the exhaust pipe and promoting reduction of nitrogen oxide in the exhaust gas; a reducing agent supply part provided in a stage before the selective reduction catalyst in the exhaust pipe and supplying the reducing agent in the supply direction; and the mixing member disposed to face the reducing agent supply part in the supply direction in the exhaust pipe.

A vehicle according to the present disclosure includes the exhaust purification apparatus described above.

Advantageous Effects of Invention

According to the present disclosure, it is possible to improve mixing efficiency of a reducing agent and an exhaust gas, and further to improve purification efficiency of the exhaust gas.

### BRIEF DESCRIPTION OF DRAWINGS

FIG. 1 is a schematic configuration diagram illustrating an exhaust system of an internal combustion engine to which an exhaust purification apparatus according to an embodiment of the present disclosure is applied;

FIG. 2 is an enlarged view of a mixing member part in the exhaust purification apparatus;

FIG. 3 is a cross-sectional view of a mixing member viewed from an emission direction; and

FIG. 4 illustrates a mixing member according to a variation.

### DESCRIPTION OF EMBODIMENTS

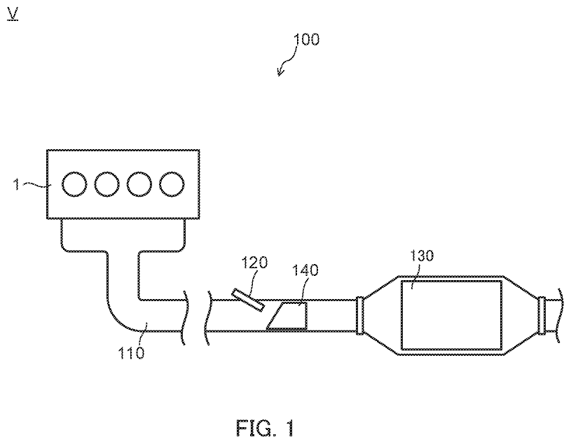

Hereinafter, an embodiment of the present disclosure will be described in detail with reference to the accompanying drawings. FIG. 1 is a schematic configuration diagram illustrating an exhaust system of internal combustion engine 1 to which exhaust purification apparatus 100 according to the embodiment of the present disclosure is applied.

As illustrated in FIG. 1, internal combustion engine 1 is, for example, a diesel engine mounted on vehicle V. Internal combustion engine 1 is provided with exhaust purification apparatus 100 for guiding an exhaust gas generated in internal combustion engine 1 into the atmosphere. Exhaust purification apparatus 100 includes exhaust pipe 110, reducing agent supply part 120, selective reduction catalyst 130, and mixing member 140.

An exhaust gas generated from internal combustion engine 1 flows through exhaust pipe 110. Exhaust pipe 110 is provided with reducing agent supply part 120, mixing member 140, selective reduction catalyst 130, and the like in this order from an upstream side of a direction in which an exhaust gas flows (a direction from the left to the right in the drawing; hereinafter, referred to as “emission direction”).

Reducing agent supply part 120 supplies a reducing agent (urea water) for generating ammonia to exhaust pipe 110. Further, reducing agent supply part 120 supplies the reducing agent in a direction inclined with respect to the emission direction (a right obliquely downward direction in the drawing; hereinafter, referred to as “supply direction”). When the reducing agent is supplied to exhaust pipe 110 by reducing agent supply part 120, the reducing agent is hydrolyzed due to the temperature in exhaust pipe 110 to generate ammonia.

Selective reduction catalyst 130 is provided in a stage after reducing agent supply part 120 in exhaust pipe 110, and adsorbs ammonia generated based on the reducing agent supplied by reducing agent supply part 120. Selective reduction catalyst 130 reacts the adsorbed ammonia with nitrogen oxide contained in an exhaust gas passing through selective reduction catalyst 130 to reduce the nitrogen oxide.

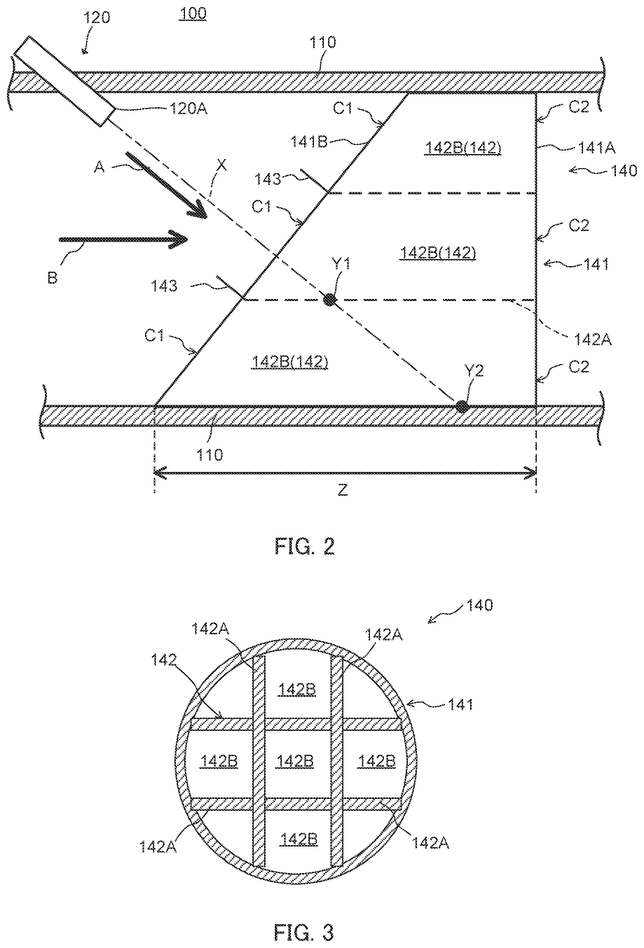

As illustrated in FIG. 2, mixing member 140 is a member that mixes the reducing agent supplied by reducing agent supply part 120, and an exhaust gas. Mixing member 140 is disposed to face reducing agent supply part 120 in supply direction A in exhaust pipe 110, and includes main body part 141, mixing part 142, and heat reception part 143.

As illustrated in FIG. 3, main body part 141 is configured to have, for example, a shape with a circular outer peripheral surface so as to be insertable into exhaust pipe 110. Note that, the shape of main body part 141 is not limited thereto, and can be appropriately changed in accordance with the shape of exhaust pipe 110.

As illustrated in FIG. 2, main body part 141 is configured to have a trapezoidal shape with an upper bottom and a lower bottom that are parallel to emission direction B in a side view. Main body part 141 includes downstream end surface 141A on a downstream side in emission direction B, and upstream end surface 141B on an upstream side in emission direction B. Downstream end surface 141A is orthogonal to emission direction B.

Upstream end surface 141B extends so as to be orthogonal to supply direction A and is inclined with respect to emission direction B such that upstream end surface 141B faces an upstream side in supply direction A when mixing member 141 is disposed in exhaust pipe 110. By configuring upstream end surface 141B in this manner, main body part 141 is capable of directly receiving the reducing agent supplied from reducing agent supply part 120 on upstream end surface 141B.

Further, upstream end surface 141B and downstream end surface 141A described above are open, and main body part 141 is configured to pass through in emission direction B. Accordingly, an opening portion of upstream end surface 141B forms gas inlet C1 for an exhaust gas, and an opening portion of downstream end surface 141A forms gas outlet C2 for an exhaust gas. Mixing part 142 is provided in an internal space of main body part 141.

As illustrated in FIG. 3, mixing part 142 is configured such that, for example, a plurality of flat plate members 142A is provided in a grid shape in main body part 141. A space formed by flat plate members 142A in mixing part 142 forms gas flow path 142B for an exhaust gas.

As illustrated in FIG. 2, gas flow path 142B communicates gas inlet Cl with gas outlet C2, is inclined with respect to supply direction A, and extends parallel to emission direction B. By configuring gas flow path 142B as such, the reducing agent that has entered mixing member 140 is surely received by mixing member 140. As a result, it is possible to improve mixing efficiency in mixing member 140, and further to improve purification efficiency in exhaust purification apparatus 100.

Heat reception part 143 protrudes from upstream end surface 141B of main body part 141 so as to intersect emission direction B. Specifically, heat reception part 143 protrudes from an upstream-side end part of flat plate member 142A forming a lower wall of gas flow path 142B, among flat plate members 142A forming gas flow paths 142B, so as to intersect emission direction B, and extends in a direction parallel to supply direction A.

Since configuring heat reception part 143 as such makes it easy for an exhaust gas moving towards mixing member 140 to collide with heat reception part 143, heat of the exhaust gas is easily transferred by heat reception part 143. As a result, mixing member 140 in its entirety is easily heated so that it is possible to improve mixing efficiency of the reducing agent, which has entered mixing member 140, and an exhaust gas.

Further, since heat reception part 143 extends in the direction parallel to supply direction A, the reducing agent of reducing agent supply part 120 easily enters mixing member 140 along heat reception part 143. As a result, mixing member 140 easily receives the reducing agent so that it is possible to improve mixing efficiency in mixing member 140, and further to improve purification efficiency in exhaust purification apparatus 100.

Further, a wall surface (flat plate member 142A) forming one of gas flow paths 142B in mixing member 140 intersects imaginary line X extending in supply direction A from supply port 120A for the reducing agent in reducing agent supply part 120. FIG. 2 indicates an example in which a wall surface forming gas flow path 142B, which is located at the middle position among gas flow paths 142B located at the uppermost, middle, and lowest positions, intersects imaginary line X at intersection Y1.

Thus, mixing member 140 is capable of easily receiving the reducing agent supplied from reducing agent supply part 120. As a result, it is possible to restrain the reducing agent from passing through gas flow path 142B, without being mixed in mixing member 140, to be deposited on exhaust pipe 110 on a downstream side of mixing member 140.

Further, mixing member 140 is preferably disposed in region Z including intersection Y2 between imaginary line X, which extends in supply direction A from supply port 120A for the reducing agent in reducing agent supply part 120, and exhaust pipe 110.

By disposing mixing member 140 in this manner, mixing member 140 is capable of surely receiving the reducing agent supplied from reducing agent supply part 120. Thus, it is possible to restrain the reducing agent from passing through gas flow path 142B, without being mixed in mixing member 140, to be deposited on exhaust pipe 110 on the downstream side of mixing member 140.

As a result, the reducing agent can be surely received by mixing member 140 so that it is possible to improve mixing efficiency in mixing member 140, and further to improve exhaust efficiency in exhaust purification apparatus 100.

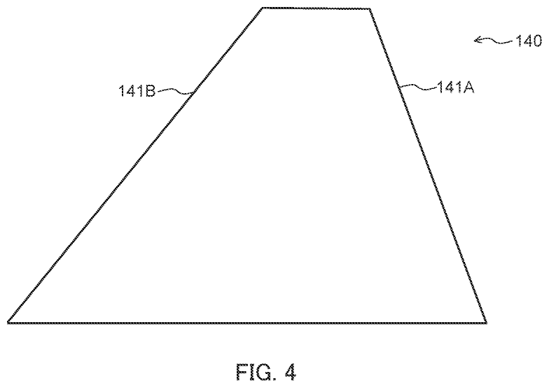

Note that, in the embodiment described above, downstream end surface 141A of mixing member 140 is orthogonal to emission direction B, but the present disclosure is not limited thereto. For example, as illustrated in FIG. 4, downstream end surface 141A may also be inclined so as to be wider downward as downstream end surface 141A is directed toward a downstream side of emission direction B. In this way, it is possible to easily restrain the reducing agent, which has passed through gas flow path 142B of mixing member 140, from being deposited on a downstream side of exhaust pipe 110 in mixing member 140.

Further, in this configuration, downstream end surface 141A is inclined such that downstream end surface 141A is located more on an upstream side of emission direction B as downstream end surface 141A is upwardly directed. Accordingly, mixing member 140 is configured such that a member located on an upper side of mixing member 140 has a small length in emission direction B. Thus, it is possible to decrease the size of mixing member 140 so that decreases in the weight and cost can be achieved. Further, since the heat capacity of mixing member 140 can be decreased by decreasing the size of mixing member 140, it is possible to contribute to a heating effect by a relatively small amount of heat.

Further, in the embodiment described above, heat reception part 143 is disposed parallel to supply direction A, but the present disclosure is not limited thereto, and heat reception part 143 may not be disposed parallel to supply direction A.

Further, in the embodiment described above, upstream end surface 141B of mixing member 140 is orthogonal to supply direction A, but the present disclosure is not limited thereto. Upstream end surface 141B may not be orthogonal to supply direction A as long as upstream end surface 141B intersects supply direction A.

Further, in the embodiment described above, heat reception part 143 is provided in mixing member 140, but the present disclosure is not limited thereto, and heat reception part 143 may not be provided.

In addition, any of the embodiment described above is only illustration of an exemplary embodiment for implementing the present disclosure, and the technical scope of the present disclosure shall not be construed limitedly thereby. That is, the present disclosure can be implemented in various forms without departing from the gist or the main features thereof.

This application is based upon Japanese Patent Application No. 2018-223380, filed on Nov. 29, 2018, the entire contents of which are incorporated herein by reference.

### INDUSTRIAL APPLICABILITY

The mixing member of the present disclosure is useful as a mixing member, an exhaust purification apparatus, and a vehicle that are capable of improving mixing efficiency of a reducing agent and an exhaust gas, and further improving purification efficiency of the exhaust gas.

### REFERENCE SIGNS LIST

1 Internal combustion engine
100 Exhaust purification apparatus
110 Exhaust pipe
120 Reducing agent supply part
120A Supply port
130 Selective reduction catalyst
140 Mixing member
141 Main body part
141A Downstream end surface
141B Upstream end surface
142 Mixing part
142A Flat plate member
142B Gas flow path
143 Heat reception part
V Vehicle
A Supply direction
B Emission direction
C1 Gas inlet
C2 Gas outlet

1. A mixing member that mixes a reducing agent and an exhaust gas in an exhaust pipe, the reducing agent being supplied in a supply direction inclined with respect to an emission direction in which the exhaust gas flows, the mixing member comprising:
a main body part including:
a gas inlet;
a gas outlet; and
a gas flow path communicating the gas inlet with the gas outlet and causing the exhaust gas and the reducing agent to be mixed therein, wherein:
the gas inlet is provided on an end surface of the main body part, the end surface being located on an upstream side in the emission direction when the mixing member is disposed in the exhaust pipe,
the end surface is disposed inclined with respect to the emission direction so as to face an upstream side in the supply direction of the reducing agent, and
the gas flow path is inclined with respect to the supply direction and extends parallel to the emission direction.

2. The mixing member according to claim 1, wherein
the end surface of the main body part extends in a direction orthogonal to the supply direction.

3. The mixing member according to claim 1, comprising a heat reception part which protrudes from the end surface of the main body part so as to intersect the emission direction, and which receives heat of the exhaust gas.

4. The mixing member according to claim 3, wherein
the heat reception part extends in a direction parallel to the supply direction.

5. An exhaust purification apparatus, comprising:
the exhaust pipe;
a selective reduction catalyst provided in the exhaust pipe and promoting reduction of nitrogen oxide in the exhaust gas;
a reducing agent supply part provided in a stage before the selective reduction catalyst in the exhaust pipe and supplying the reducing agent in the supply direction; and
the mixing member according to claim 1 disposed to face the reducing agent supply part in the supply direction in the exhaust pipe.

6. The exhaust purification apparatus according to claim 5, wherein
a wall surface forming the gas flow path intersects an imaginary line extending in the supply direction from a supply port of the reducing agent.

7. The exhaust purification apparatus according to claim 6, wherein
the mixing member is disposed in a region including an intersection between the imaginary line and the exhaust pipe.

8. A vehicle, comprising the exhaust purification apparatus according to claim 5.
